(19) United States
(12) Patent Application Publication
(10) Pub. No.: US 2007/0018347 A1
(43) Pub. Date: Jan. 25, 2007

(54) METHOD FOR MANUFACTURING GLASS-LIKE CARBON MOLDED BODY, AND GLASS-LIKE CARBON MOLDED BODY

(75) Inventor: Maki HAMAGUCHI, Kobe-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/421,209

(22) Filed: May 31, 2006

(30) Foreign Application Priority Data
Jul. 21, 2005 (JP) 2005-211586

(51) Int. Cl. B32B 9/00

(52) U.S. Cl. 264/29.6; 428/408

(57) ABSTRACT

A method for manufacturing a glass-like carbon molded body is provided which can obtain an excellent glass-like carbon molded body without cracks from a thermosetting resin molded body having a large thickness exceeding, for example, 10 mm, unlike in the conventional method in which an upper limit of the resin molded body has been, for example, 7 mm, even at the rate of temperature increase that is industrially practical considering the productivity at a carbonization step of heating the thermosetting resin molded body when manufacturing the glass-like carbon molded body. The method for manufacturing a glass-like carbon molded body comprises a step of carbonizing a thermosetting resin molded body by heating the molded body in inert atmosphere. The thermosetting resin molded body has one or more opened vent holes on a surface thereof, and satisfies the following formula, in which r (mm) is either a distance from an arbitrary point inside the thermosetting resin molded body to an outer surface thereof, or a distance from the arbitrary point to a surface of the vent hole, whichever is shorter, and x (° C./h) is an average rate of temperature increase in a range of 400 to 600° C. at the carbonization step: r<(8.0−x·a)/2, where a=1 (mm·h/° C.).

### FIELD OF THE INVENTION

The present invention relates to a method for manufacturing a glass-like carbon molded body which is made of glass-like carbon, and used in a jig or part of a heat treatment furnace, a part of a semiconductor manufacturing device, or the like, and to a glass-like carbon molded body manufactured by the same.

### BACKGROUND OF THE INVENTION

Unlike graphite which is made of the same carbon element, glass-like carbon has properties including substantial non-permeability to gases, excellent surface smoothness, excellent hardness, and high chemical stability. Utilizing these properties, a glass-like carbon molded body has been used in a jig or part of a heat treatment furnace, a part of a semiconductor manufacturing device, or the like.

The glass-like carbon molded body is manufactured by carbonizing a molded article made of a thermosetting resin, such as a phenolic resin, in an inert gas at high temperature (normally, at 1000° C. or more). The reason for use of the thermosetting resin is that it normally has a carbon yield of 60% or more, in some cases, a high yield of 80% or more, with no large deformation at the carbonizing period. (In contrast, the use of a thermoplastic resin softens and melts a molded article, which consequently loses its shape.)

A main restraint on manufacturing of the glass-like carbon molded body is due to the fact that various gas components are generated when the thermosetting resin is carbonized. The main gases generated include, for example, water (water vapor), CO₂, CO, CH₄ (methane), C₂H₄ (ethylene), and H₂ (hydrogen), from the lower temperature side. These gas components are generated inevitably during a curing reaction, a polycondensation reaction, or a thermal decomposition reaction of the resin, which is a precursor of the glass-like carbon. Since diffusion rates of these gases in the molded body in carbonization are not necessarily high, an internal pressure in a thermosetting resin molded body becomes large due to the generation of gases during the carbonization. When the internal pressure exceeds a given range, cracks may sometimes be caused in the thermosetting resin molded body during the carbonization, or material itself may sometimes be broken. To avoid these phenomena, the carbonization is normally carried out at extremely low rates of temperature increase, such as at 0.5 to 5° C./h. Particularly, the material tends to break readily in a temperature range of about 400 to 600° C. In this temperature range, the rate of temperature increase needs to be set carefully.

For this reason, a thermosetting resin molded body having a small thickness can be processed at the relatively high rates of temperature increase, whereas a thermosetting resin molded body having a large thickness should be carbonized at the lower rates of temperature increase. From an industrial point of view, as the rate of temperature increase becomes significantly low, productivity is decreased markedly, and hence the largest thickness of the thermosetting resin molded body to be subjected to carbonization is limited to about 7 mm. In other words, the manufacturing of the glass-like carbon molded body has a problem that the thickness of the resin molded body cannot be set arbitrarily to a larger value. That is, as long as the rate of temperature increase is employed which is industrially practical considering the productivity, the thickness of the resin molded body is limited. The upper limit of the thickness of the thermosetting resin molded body depends on a resin material and a manufacturing method to some extent, but is around 10 mm even by using a specific method, normally about 7 mm.

It has been disclosed in detail in the following document that a thickness of a resin molded body, and rates of temperature increase in curing and carbonizing process may have an influence on the formation of defects when a glass-like carbon molded body is manufactured by carbonizing a phenolic resin molded body. See H. Maleki et al., “Determining the shortest production time for glass-likecarbonware”, in carbon, Vol. 35, No. 2, pp. 227-234 (1997). However, this document describes only the upper limit of the rate of temperature increase according to the thickness of the phenolic resin molded body, and fails to disclose a method for manufacturing a glass-like carbon molded body having a large thickness.

A method for manufacturing a glass-like carbon molded body having a large thickness has been proposed which involves using a thermosetting resin molded body having fine pores as a starting material. This method, however, manufactures a porous glass-like carbon, and thus cannot provide a glass-like carbon molded body having the chemical surface stability, and non-permeability to gases or liquid, which are basically the properties of original glass-like carbon.

### SUMMARY OF THE INVENTION

It is an object of the invention to provide a method for manufacturing a glass-like carbon molded body which can obtain an excellent glass-like carbon molded body without cracks and breakage from a thermosetting resin molded body having a large thickness exceeding, for example, 10 mm, unlike in the conventional method in which an upper limit of the resin molded body has been, for example, 7 mm, even at the rate of temperature increase that is industrially practical considering the productivity at a carbonization step of heating the thermosetting resin molded body when manufacturing the glass-like carbon molded body. Furthermore, it is another object of the invention to provide a glass-like carbon molded body manufactured by the same.

In order to solve the above-mentioned problems, the invention has the following technical means.

In a first aspect of the invention, a method for manufacturing a glass-like carbon molded body comprises a step of carbonizing a thermosetting resin molded body by heating the molded body in inert atmosphere. The thermosetting resin molded body has one or more opened vent holes on a surface thereof, and satisfies the following formula (1), in which r (mm) is either a distance from an arbitrary point inside the thermosetting resin molded body to an outer surface thereof, or a distance from the arbitrary point to a surface of the vent hole, whichever is shorter, and x (° C./h) is an average rate of temperature increase in a range of 400 to 600° C. at the carbonization step,
r<(8.0−x·a)/2 (1)
where a=1 (mm·h/° C.).

In the method for manufacturing a glass-like carbon molded body as defined in the first aspect, the r in the formula (1) satisfies the following condition: 1<r.

In a second aspect of the invention, a method for manufacturing a glass-like carbon molded body comprises a step of carbonizing a thermosetting resin molded body by heating the molded body in inert atmosphere. The thermosetting resin molded body has one or more opened vent holes on a surface thereof, and the plurality of vent holes are formed and arranged to satisfy the following formula (2), in which D (mm) is an equivalent diameter of the vent hole, P (mm) is a pitch between the holes, x (° C./h) is an average rate of temperature increase in a range of 400 to 600° C. at the step of carbonization,
(P−D)<(8.0·x·a) (2)
where a=1 (mm·h/° C.).

In the method for manufacturing a glass-like carbon molded body as defined in the second aspect, the (P−D) in the formula (2) satisfies the following condition: 1<(P−D).

In the method for manufacturing a glass-like carbon molded body as defined in the second aspect, for the vent hole having a substantially circular section, the equivalent diameter D is a diameter of the vent hole. When the plurality of vent holes are regularly arranged in a square shape, a distance between apexes of the square on a diagonal line thereof is set as the hole pitch P. When the plurality of vent holes are regularly arranged in an equilateral triangle shape, a distance between apexes of the equilateral triangle is set as the hole pitch P.

In the method for manufacturing a glass-like carbon molded body as defined in the second aspect, for the vent hole having a substantially circular section, the equivalent diameter D is a diameter of the vent hole. When the plurality of vent holes are arranged nonlinearly, or irregularly, if the number of the vent holes per area is represented by N (pieces/cm²), then the hole pitch P is defined as P=2 (100/Nπ)^{1/2}.

Further, a slot connecting all or parts of the plurality of vent holes arranged nonlinearly or irregularly is formed as another vent hole.

In the method for manufacturing a glass-like carbon molded body as defined in the second aspect, when the vent hole is a slot-like vent hole that is formed as a slot, the equivalent diameter D is a width of the slot-like vent hole. When the plurality of slot-like vent holes are regularly arranged linearly in parallel to each other, a distance between the center lines of the adjacent slot-like vent holes is set as the hole pitch P.

In the method for manufacturing a glass-like carbon molded body as defined in the second aspect, the vent hole is a through hole.

In the method for manufacturing a glass-like carbon molded body as defined in the second aspect, a thickness of the thermosetting resin molded body in a depth direction of the vent hole may be greater than 10 mm.

In a third aspect of the invention, a glass-like carbon molded body is obtained by the method as defined in the second aspect.

In the method for manufacturing a glass-like carbon molded body according to the second aspect of the invention, one or more opened vent holes are formed and arranged on the surface of the thermosetting resin molded body, by setting the thickness between the adjacent vent holes in the molded body (hole pitch P-equivalent diameter D) so as to reflect the average rate of temperature increase x in the range of 400 to 600° C. at the carbonization step. Thus, the gas generated in the thermosetting resin molded body can be released outward sufficiently through the vent holes even at the rate of temperature increase that is industrially practical considering the productivity at the carbonization step of heating the molded body. This can provide an excellent glass-like carbon molded body without cracks and breakage from the thermosetting resin molded body having a large thickness exceeding, for example, 10 mm, unlike in the conventional method in which an upper limit of the resin molded body has been, for example, 7 mm. The glass-like carbon molded body of the invention, which has the large thickness as compared to the conventional one, can contribute to a wide range of applications of the glass-like carbon molded body.

### BRIEF DESCRIPTION OF THE DRAWINGS

Embodiments of the present invention will be described in detail based on the following figures, wherein:

FIG. 1A is a sectional view of a thermosetting resin molded body having individual vent holes according to one preferred embodiment of the invention;

FIG. 1B is a sectional view of another thermosetting resin molded body having slot-like vent holes that connect individual vent holes according to another preferred embodiment of the invention;

FIG. 2 is a perspective view showing an example of a thermosetting resin molded body according to another preferred embodiment of the invention;

FIG. 3A is a plan view showing an example of a thermosetting resin molded body according to another preferred embodiment of the invention;

FIG. 3B is a front view of the thermosetting resin molded body as viewed from an arrow D of FIG. 3A;

FIG. 4 is a sectional view of a thermosetting resin molded body having vent holes in Example 1;

FIG. 5A is a perspective view of a thermosetting resin molded body having vent holes in Example 4;

FIG. 5B is a sectional view taken along a line A-A of FIG. 5A;

FIG. 6A is a perspective view of a thermosetting resin molded body having vent holes in Example 5;

FIG. 6B is a sectional view taken along a line B-B of FIG. 6A;

FIG. 7A is a perspective view of a thermosetting resin molded body having vent holes in Example 6;

FIG. 7B is a sectional view taken along a line C-C of FIG. 7A; and

FIG. 8 is a sectional view of a thermosetting resin molded body having vent holes in Example 7.

### DETAILED DESCRIPTION OF THE PREFERRED EMBODIMENTS

Reference will now be made to some preferred embodiments of the invention, which are illustrated in the accompanying drawings. In a method for manufacturing a glass-like carbon molded body according to the invention, a thermosetting resin molded body having a plurality of opened vent holes formed on its surface is used at a step of carbonizing the thermosetting resin molded body by heating the molded body in inert atmosphere. These vent holes serve as a vent path (a path for diffusion) through which a gaseous product (gas) generated by the carbonization reaction flows outward so as to prevent fractures or cracks from occurring in the thermosetting resin molded body, or to avoid the molded body from being broken at the carbonization step.

In forming the vent holes in the thermosetting resin molded body, the following requirements are used to easily manufacture a glass-like carbon molded body having a large thickness, as compared to the prior art. First, the manufacturing method of the embodiment uses the thermosetting resin molded body with a plurality of vent holes formed thereon that satisfy the following formula (1), in which D (mm) is an equivalent diameter of a vent hole, P (mm) is a pitch between the holes, and x (° C./h) is an average rate of temperature increase in a range of 400 to 600° C. at the step of carbonization. Note that in the following formula (2), a=1 (mm·h/° C.)
(P−D)<(8.0−x·a) (2)

The diameter of the vent hole is preferably 1 mm or more from a viewpoint of the vent effect (gas diffusion effect) by the vent holes, and workability of the vent hole. The vent hole may be a through hole or a non-through hole, either of which can have the same effect, and be selected according to the property required for the glass-like carbon molded body.

The equivalent diameter D (mm) of the vent hole is a diameter of the vent hole when the vent hole has a substantially circular section, or a diameter of a circle having the same sectional area as that of the vent hole when the vent hole has a non-circular section (except for the slot-like vent hole).

The pitch between the vent holes P (mm) is defined as follows. (I) In a case where the vent holes are arranged regularly, 1) for the vent holes positioned linearly, a distance between center points of the adjacent vent holes is set as the hole pitch P; 2) for the vent holes positioned in a square shape, a distance between apexes of the square on a diagonal line thereof is set as the hole pitch P; and 3) for the vent holes positioned in an equilateral triangle shape, a distance between apexes of the equilateral triangle is set as the hole pitch P. Alternatively, (II) in a case where the vent holes are arranged nonlinearly, for example, concentrically, or irregularly, if an area density of the vent holes is represented by N (pieces/cm²) then the hole pitch P may be defined as P=2 (100/Nπ)^{1/2}. The hole pitch P of the vent hole as defined above is set within a range that satisfies the above-mentioned formula (2).

The (hole pitch P-equivalent diameter D) in the formula (1) is an indicator representing a thickness of a part between the adjacent vent holes in the thermosetting resin molded body. The inventor has found that there is a constant relationship between the (P−D) value that allows for carbonization without causing cracks in the thermosetting resin molded body, and an average rate of temperature increase x in a range of 400 to 600° C. in carbonization (=200/time required for increasing the temperature from 400 to 600° C.). Based on the findings, the invention has been accomplished. That is, when the (P−D) value is less than (8.0−x·a), carbonization can be performed without causing fractures and cracks. In contrast, when the (P−D) value is too small, for example, less than 1 mm, the thermosetting resin molded body may be broken at the carbonization step because of insufficient strength of the molded body, or the strength of a glass-like carbon molded body obtained may not be sufficient. Thus, the vent holes may be preferably formed such that the (P−D) value is greater than 1 mm.

The sectional shape of the vent hole of the invention is not necessarily circular, and may be triangular, rectangular, or star-shaped, for example. The shape of vent hole of the invention may not necessarily have a polygonal pole, such as a circular cylinder, a triangle pole, or a square pole. In the invention, when r (mm) is either a distance from an arbitrary point inside the thermosetting resin molded body to an outer surface thereof, or a distance from the arbitrary point to a surface of the vent hole, whichever is shorter, the vent hole may be formed so as to satisfy the following equation (1). In this case, when the r is too small, for example, 1 mm or less, the strength of the glass-like carbon molded body obtained may not be sufficient. Thus, preferably, the vent holes in the thermosetting resin molded body are formed such that the r is greater than 1 mm.
r<(8.0−x·a)/2 (1)

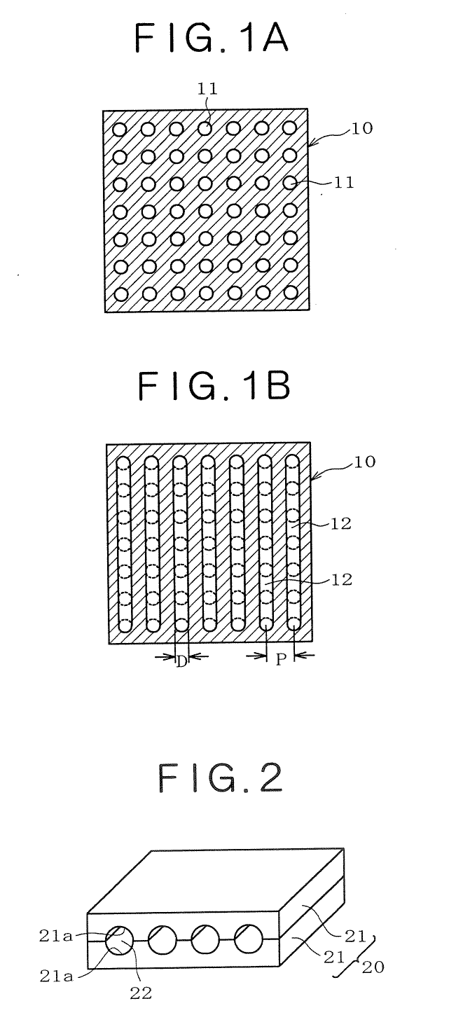

The vent holes are provided for the purpose of preventing cracks and breakage from occurring in the thermosetting resin molded body due to generation of gases at the carbonization step. The vent holes having the circular section do not need to be individually formed. That is, the vent holds of the thermosetting resin molded body 10 may include vent holes 11 (through hole) whose circular sections are arranged individually as shown in FIG. 1A, and slot-like vent holes 12 connecting these vent holes 11 as shown in FIG. 1B.

For the slot-like vent hole, the equivalent diameter D is a width dimension of the slot-like vent hole. When these slot-like vent holes are regularly arranged linearly in parallel to each other, a distance between the center lines of the adjacent slot-like vent holes is set as the above-mentioned hole pitch P (see FIG. 1B).

When the vent hole is a circular vent hole having a substantial circular section, if these circular vent holes are arranged non-linearly, or concentrically, for example, a slot connecting parts of these vent holes may be formed as the vent hole.

The use of the method for manufacturing a glass-like carbon molded body according to the invention can obtain the glass-like carbon molded body from a thermosetting resin molded body having a large thickness of, for example, 10 mm or more, in a depth direction of the vent hole, without substantially imposing any limitation on the thickness of the thermosetting resin molded body serving as a precursor.

The thermosetting resin molded body having the vent holes as mentioned above can be manufactured by the known method. For example, a thermosetting resin, such as a phenolic resin, or a furan resin, is molded into the thermosetting resin molded body having the desired shape, using a molding method appropriately selected from the known molding methods, including compression molding, injection molding, and cast molding. Thereafter, predetermined vent holes are formed by machining or the like. Alternatively, in another method, when the thermosetting resin is molded by the molding method appropriately selected, a die may be used in advance which has a structure that is designed to form the predetermined vent holes.

In a further method, as shown in FIG. 2, a thermosetting molded body 20 having vent holes 22 is obtained by bonding thermosetting resin substrates 21 and 21 having grooves 21a and 21a previously formed together such that the grooves 21a and 21a are aligned with each other. In this case, as a method for bonding the substrates 21 and 21, can be used the known method, such as thermo compression bonding using the thermosetting resin as an adhesive. This method is suitable for forming the vent holes 22 in such a manner that they are extended in parallel to one another over a wide surface of the molded body 20. Also, the method is suited for obtaining the thermosetting resin molded body 20 having the large thickness in the depth direction of the vent hole 22.

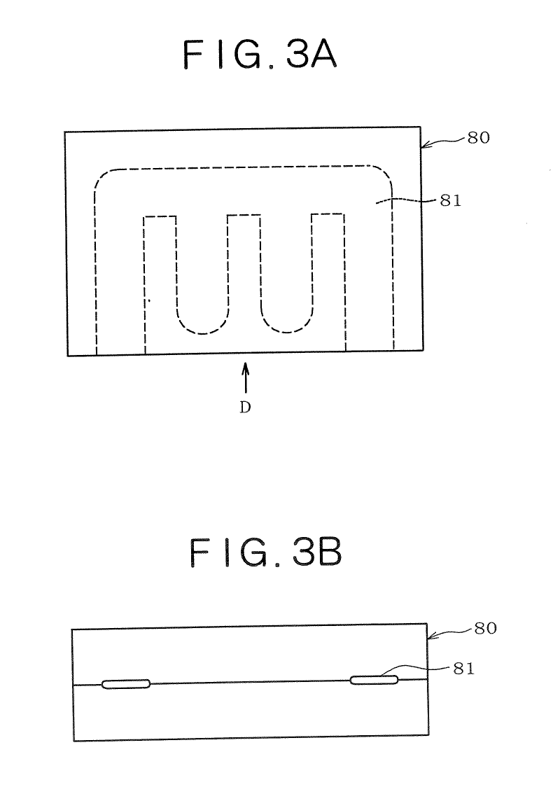

FIG. 3A shows a plan view showing an example of a thermosetting resin molded body according to another preferred embodiment, and FIG. 3B is a front view of the molded body as viewed from an arrow D of FIG. 3A. One vent hole 81 is formed in a thermosetting resin molded body 80, which is assembled by thermo compression bonding using the thermosetting resin as an adhesive.

Carbonizing the thermosetting resin molded body having the vent hole formed thereon can be performed by the known carbonization method. That is, the carbonization method may involve applying a curing process to the thermosetting resin molded body as required, and heating the molded body at high temperature, normally, at 1000° C. or more, in inert atmosphere (nitrogen, argon, or the like), thereby converting the molded body into a glass-like carbon. The curing process is to prevent thermal deformation at the carbonization step, and is preferably carried out by heating at a temperature around 200° C. for 10 hours in air or in an atmosphere in which a concentration of oxygen is controlled. It is important that the rate of temperature increase at the carbonization step is set not to deviate from the relationship represented by the formula (1).

It should be noted that the glass-like carbon molded body obtained by the method of the invention can be subjected to cutting, polishing, or the like if necessary.

### EXAMPLES

Examples of the invention will be described below in detail.

A thermosetting resin molded body was obtained by pouring a commercially available liquid phenolic resin PL-4804 manufactured by Gun Ei Chemical Industry Co., Ltd., into a predetermined die, and curing the resin under a reduced pressure at 70° C. for 20 hours. Then, vent holes having various equivalent diameters D (mm) as described later were formed in the resin molded body, while varying a pitch between the holes P. The thermosetting resin molded body was subjected to post-curing at 230° C. for 100 hours. Thereafter, the thermosetting resin molded body provided with the vent holes was carbonized by being heated in inert atmosphere.

The carbonization process was carried out by changing the rate of temperature increase in nitrogen atmosphere as follows. In a temperature range of room temperature to 400° C., the rate of temperature increase was fixed to 2° C./h. In a temperature range of 400 to 600° C., a rate of temperature increase x is changed as shown in Table 1 for each of Examples and Comparative Examples. In a temperature range of 600 to 800° C., a rate of temperature increase is fixed to 5° C./h.

The way to form the vent holes in the thermosetting resin molded body, a condition of carbonization (average rate of temperature increase x in the temperature range of 400 to 600° C.), and the like are shown in Table 1 as a whole. The evaluation (presence or absence of fractures and cracks) of the thermosetting resin molded bodies carbonized are shown in Table 2.

### Example 1

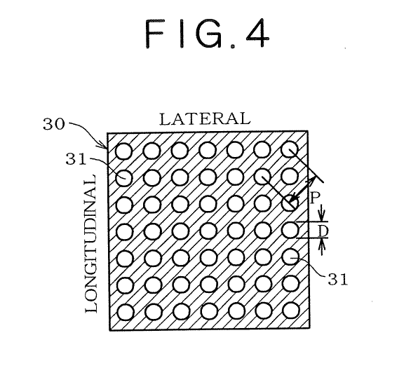

Forty-nine vent holes 31 were formed by punching 49 through holes having a circular section of 3 mm in diameter (D) on a surface of 38 mm by 38 mm in a rectangular parallelepiped thermosetting resin molded body of 38-mm longitudinal by 38-mm lateral by 20-mm thickness such that the through holes were arranged in a square shape with a hole pitch (P) set to 7.1 mm. FIG. 4 is a sectional view of a thermosetting resin molded body 30 having the vent holes in Example 1. The average rate of temperature increase x in the temperature range of 400 to 600° C. was set to 2.0° C./h. The thus-obtained thermosetting resin molded body 30 satisfied the formulas (1) and (2) as defined by the invention, so that a good glass-like carbon molded body having no failures, such as fractures, cracks, and chipping, was obtained. Note that the ratio of hole area in the thermosetting resin molded body (the rate of a total sectional area of all vent holes to the total area of a surface (I surface) with the vent holes formed thereon) was 24%.

### Example 2

The same thermosetting resin molded body as that of Example 1 was used, and carbonized with the average rate of temperature increase x in the temperature range of 400 to 600° C. set to 3.0° C./h. The thermosetting resin molded body satisfied the formulas (1) and (2) as defined by the invention, resulting in a good glass-like carbon molded body having no failures, such as fractures, cracks, and chipping.

### Comparative Example 1

The different point from Example 1 was that the average rate of temperature increase x in the temperature range of 400 to 600° C. was twice as large as that of Example 1, namely, 4.0° C./h. The thermosetting resin molded body of Comparative Example 1 had the same diameter of the vent hole D as those of Examples 1 and 2, but had the larger average rate of temperature increase x than those of Examples 1 and 2. For this reason, the molded body of Comparative Example 1 did not satisfy the following formulas (1) and (2) as defined by the invention. As a result, the thus-obtained glass-like carbon molded body was not able to release the gas sufficiently, thus causing cracks.

### Example 3

The same thermosetting resin molded body as those of Examples 1, 2, and Comparative Example 1 except that the diameter (D) of the vent hole was 3.8 mm was used, and carbonized with the average rate of temperature increase x in the range of 400 to 600° C. set to 4.0° C./h. Although the average rate of temperature increase x was larger in this example, the diameter D of the vent hole was larger than that of Comparative Example 1, whereby the thermosetting resin molded body satisfied the formulas (1) and (2) as defined by the invention, resulting in a good glass-like carbon molded body having no failures, such as fractures, blisters, and chipping.

### Comparative Example 2

The same thermosetting resin molded body as that of Example 1 except that the diameter (D) of the vent hole was 1.0 mm was used, and carbonized with the average rate of temperature increase x in the range of 400 to 600° C. set to 2.0° C./h. In the thermosetting resin molded body of Comparative Example 2, even though the average rate of temperature increase x was the same as that of Example 1, the diameter D of the vent hole was too small, as compared to Example 1. The resin molded body of this Comparative Example 2 did not satisfy the formulas (1) and (2) as defined by the invention. As a result, the thus-obtained glass-like carbon molded body was not able to release the gas sufficiently, thus causing cracks.

### Example 4

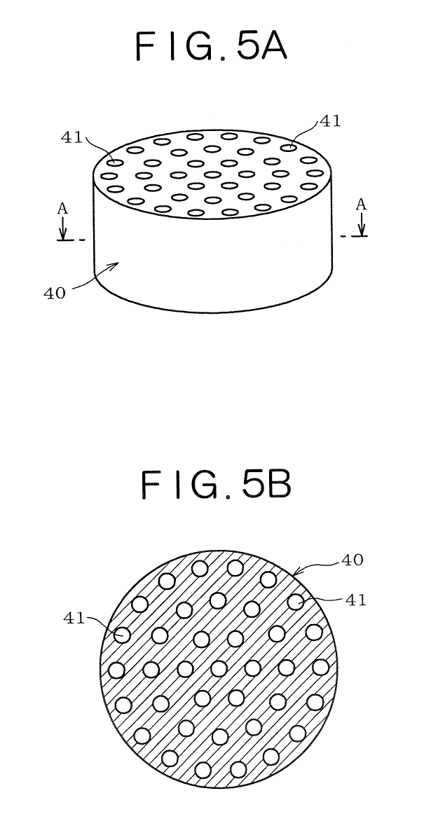

Thirty-seven vent holes 41 were formed by punching 37 through holes each having a circular section of 4 mm in diameter (D) concentrically in a disk-shaped thermosetting resin molded body of 56-mm diameter by 20-mm thickness. FIG. 5A is a perspective view of a thermosetting resin molded body 40 having the vent holes in Example 4, and FIG. 5B is a sectional view taken along a line A-A of FIG. 5A. The distance between concentric circles was 8 mm. The hole pitch (P) of the vent hole was determined to be 9.2 mm from an area density of the vent holes, and the ratio of hole area was determined to be 19% therefrom. The average rate of temperature increase x in the rage of 400 to 600° C. was set to 1.0° C./h. The thermosetting resin molded body 40 satisfied the formulas (1) and (2) as defined by the invention, resulting in a good glass-like carbon molded body having no failures, such as fractures, blisters, and chipping.

### Example 5

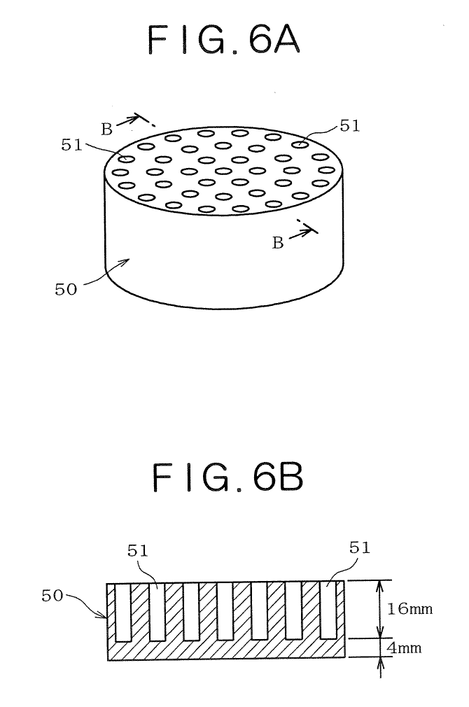

The same condition as that of Example 4 except that a vent hole 51 was a non-through hole of 16 mm in depth was used. FIG. 6A is a perspective view of a thermosetting resin molded body 50 having vent holes in Example 5, and FIG. 6B is a sectional view taken along a line B-B of FIG. 6A. The thus-obtained glass-like carbon molded body was good without any failures, such as fractures, blisters, and chipping.

### Example 6

In the same disk-shaped thermosetting resin molded body as that of Example 4 of 56-mm diameter by 20-mm thickness, 37 through holes each having a circular section of 4 mm in diameter were punched concentrically. Thereafter, while one through hole 61 positioned at the center of the body was maintained, a slot-like vent hole 62 which was a through hole having an arc shape in plan view was formed by cutting and connecting two through holes arranged on a concentric circle having the smallest diameter. Similarly, the slot-like vent holes 62 which were through holes each having an arc shape in plan view were formed by cutting and connecting three through holes arranged on a concentric circle having the middle diameter as well as three through holes arranged on a concentric circle having the large diameter.

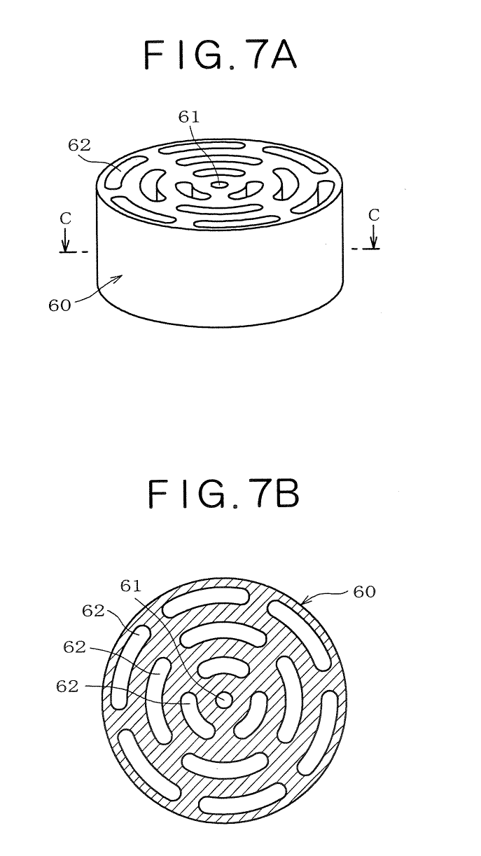

FIG. 7A is a perspective view of a thermosetting resin molded body 60 having vent holes in Example 6, and FIG. 7B is a sectional view taken along a line C-C of FIG. 7A. In this case, the equivalent diameter D of the vent hole was 4 mm, and the hole pitch P was 9.2 mm, which were the same as those of Example 4. The average rate of temperature increase x in the range of 400 to 600° C. was set to 1.0° C./h. The thermosetting resin molded body 60 satisfies the formulas (1) and (2) as defined by the invention, resulting in a good glass-like carbon molded body having no failures, such as fractures, blisters, and chipping.

### Example 7

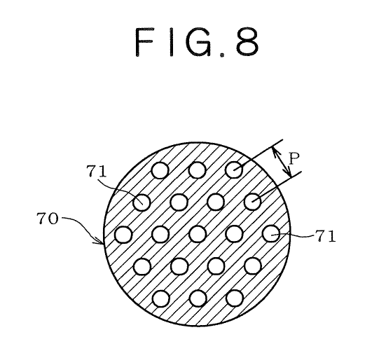

Nineteen vent holes 71 were formed by punching 19 through holes each having a circular section of 3.5 mm in diameter (D) in a disk-shaped thermosetting resin molded body of 26-mm diameter by 20-mm thickness. FIG. 8 is a sectional view of a thermosetting resin molded body 70 having vent holes in Example 7. The hole pitch (P) was 5.0 mm, and the ratio of hole area was 34%. The average rate of temperature increase in the range of 400 to 600° C. was 2.0° C./h. The thermosetting resin molded body 70 satisfied the formulas (1) and (2) as defined by the invention, resulting in a good glass-like carbon molded body having no failures, such as fractures, cracks, and chipping.

### Comparative Example 3

The different point from Example 7 was that the diameter of vent hole (D) was 4 mm, resulting in the (P−D) value=1 mm, and r=0.89. A thermosetting resin molded body of Comparative Example 3 did not satisfy the following condition: (P−D)>1, r>1, as defined by the invention, which caused serious fractures in a glass-like carbon molded body obtained.

TABLE 1

| | | | Pitch | | | | Rate of | | | | |
|---|---|---|---|---|---|---|---|---|---|---|---|
| | Size of resin | | between | Diameter | | Ratio | temperature | | | | |
| | molded body | Number | holes | of | Arrangement | of hole | increase | *P − **D | 8 − x · a | r | (8 − x · a)/2 |
| Category | (mm) | of holes | (mm) | hole (mm) | of holes | area (%) | (° C./h) | (mm) | (mm) | (mm) | (mm) |
| Example 1 | 38 × 38 × 20 | 49 | 7.1 | 3.0 | Square | 24 | 2.0 | 4.1 | 6.0 | 2.05 | 3 |
| Example 2 | 38 × 38 × 20 | 49 | 7.1 | 3.0 | Square | 24 | 3.0 | 4.1 | 5.0 | 2.05 | 2.5 |
| Comparative | 38 × 38 × 20 | 49 | 7.1 | 3.0 | Square | 24 | 4.0 | 4.1 | 4.0 | 2.05 | 2 |
| Example 1 | | | | | | | | | | | |
| Example 3 | 38 × 38 × 20 | 49 | 7.1 | 3.8 | Square | 38 | 4.0 | 3.3 | 4.0 | 1.65 | 2 |
| Comparative | 38 × 38 × 20 | 49 | 7.1 | 1.0 | Square | 3 | 2.0 | 6.1 | 6.0 | 3.05 | 3 |
| Example 2 | | | | | | | | | | | |
| Example 4 | 56φ × 20 t | 37 | 9.2 | 4.0 | Concentric | 19 | 1.0 | 5.2 | 7.0 | 3.40 | 3.5 |
| | | | | | circle | | | | | | |
| Example 5 | 56φ × 20 t | 37 | 9.2 | 4.0 | Concentric | 19 | 1.0 | 5.2 | 7.0 | 3.40 | 3.5 |
| | | | | | circle | | | | | | |
| Example 6 | 56φ × 20 t | 37 | 9.2 | 4.0 | Concentric | 36 | 1.0 | 5.2 | 7.0 | 3.40 | 3.5 |
| | | | | | circle | | | | | | |
| Example 7 | 26φ × 20 t | 19 | 5.0 | 3.5 | Equilateral | 34 | 2.0 | 1.5 | 6.0 | 1.14 | 3 |
| | | | | | triangle | | | | | | |
| Comparative | 26φφ × 20 t | 19 | 5.0 | 4.0 | Equilateral | 45 | 2.0 | 1.0 | 6.0 | 0.89 | 3 |
| Example 3 | | | | | triangle | | | | | | |

*P = Pitch between holes
**D = Diameter of hole

TABLE 2

| | Condition after | |
|---|---|---|
| Category | carbonization | Note |
| Example 1 | Good | |
| Example 2 | Good | |
| Comparative Example 1 | Cracks | |
| Example 3 | Good | |
| Comparative Example 2 | Cracks | |
| Example 4 | Good | Through hole |
| Example 5 | Good | Non-through |
| | | hole |
| Example 6 | Good | Slot |
| Example 7 | Good | |
| Comparative Example 3 | Breakage | |

The foregoing invention has been described in terms of preferred embodiments. However, those skilled, in the art will recognize that many variations of such embodiments exist. Such variations are intended to be within the scope of the present invention and the appended claims.

What is claimed is:

1. A method for manufacturing a glass-like carbon molded body, comprising a step of carbonizing a thermosetting resin molded body by heating the molded body in inert atmosphere,
wherein said thermosetting resin molded body has one or more opened vent holes on a surface thereof, the thermosetting resin molded body satisfying the following formula (1):
r<(8.0−x·a)/2 (1)
where, for a=1 (mm·h/° C.), r (mm) is either a distance from an arbitrary point inside the thermosetting resin molded body to an outer surface thereof, or a distance from the arbitrary point to a surface of the vent hole, whichever is shorter, and x (° C./h) is an average rate of temperature increase in a range of 400 to 600° C. at the carbonization step.

2. The method for manufacturing a glass-like carbon molded body according to claim 1, wherein the r in the formula (1) satisfies the following condition: 1<r.

3. A method for manufacturing a glass-like carbon molded body, comprising a step of carbonizing a thermosetting resin molded body by heating the molded body in inert atmosphere,
wherein said thermosetting resin molded body has one or more opened vent holes on a surface thereof, said vent hole is formed and arranged to satisfy the following formula (2),
(P−D)<(8.0−x·a) (2)
where, for a=1 (mm h/° C.), D (mm) is an equivalent diameter of the vent hole, P (mm) is a pitch between the holes, x (° C./h) is an average rate of temperature increase in a range of 400 to 600° C. at the step of carbonization.

4. The method for manufacturing a glass-like carbon molded body according to claim 3, wherein the (P−D) in the formula (2) satisfies the following condition: 1<(P−D).

5. The method for manufacturing a glass-like carbon molded body according to claim 3, wherein, when the vent hole has a substantially circular section, the equivalent diameter D is a diameter of the vent hole,
wherein, when the plurality of vent holes are regularly arranged in a square shape, a distance between apexes of the square on a diagonal line thereof is set as the hole pitch P, and
wherein, when the plurality of vent holes are regularly arranged in an equilateral triangle shape, a distance between apexes of the equilateral triangle is set as the hole pitch P.

6. The method for manufacturing a glass-like carbon molded body according to claim 3, wherein, when the vent hole has a substantially circular section, the equivalent diameter D is a diameter of the vent hole, and
wherein, when the plurality of vent holes are arranged nonlinearly, or irregularly, if the number of the vent holes per area is represented by N (pieces/cm²), then the hole pitch P is defined as P=2 (100/Nπ)^{1/2}.

7. The method for manufacturing a glass-like carbon molded body according to claim 6, wherein a slot connecting all or parts of the plurality of vent holes arranged nonlinearly or irregularly is formed as another vent hole.

8. The method for manufacturing a glass-like carbon molded body according to claim 3, wherein, when the vent hole is a slot-like vent hole that is formed as a slot, the equivalent diameter D is a width of the slot-like vent hole, and
wherein, when the plurality of slot-like vent holes are regularly arranged linearly in parallel to each other, a distance between the center lines of the adjacent slot-like vent holes is set as the hole pitch P.

9. The method for manufacturing a glass-like carbon molded body according to claim 3, wherein the vent hole is a through hole.

10. The method for manufacturing a glass-like carbon molded body according to claim 3, wherein a thickness of the thermosetting resin molded body in a depth direction of the vent hole is greater than 10 mm.

11. A glass-like carbon molded body obtained by the method according to claim 3.
